(19) United States
(12) Patent Application Publication
(10) Pub. No.: US 2024/0055997 A1
(43) Pub. Date: Feb. 15, 2024

(54) SWITCHING POWER SUPPLY DEVICE AND CHARGING SYSTEM

(71) Applicants: Masanari TAKANO, Aichi (JP); Masahiro YAMAGAMI, Aichi (JP); Yasumichi OMOTO, Aichi (JP)

(72) Inventors: Masanari TAKANO, Aichi (JP); Masahiro YAMAGAMI, Aichi (JP); Yasumichi OMOTO, Aichi (JP)

(73) Assignee: NIDEC MOBILITY CORPORATION, Aichi (JP)

(21) Appl. No.: 18/446,478

(22) Filed: Aug. 9, 2023

(30) Foreign Application Priority Data
Aug. 10, 2022 (JP) 2022-128136

(51) Int. Cl. H02M 3/335; H02M 1/00; H02J 7/00

(52) U.S. Cl. CPC H02M 3/33592; H02M 1/0009; H02J 7/007182; H02J 2207/20

(57) ABSTRACT

A control unit controls a synchronous rectifier circuit to rectify a current flowing through a secondary side of a transformer at a timing when an absolute value of a first current flowing through a primary side of the transformer in a first direction when a first switching element and a second switching element are turned on or at a timing when the absolute value of a second current flowing through the primary side of the transformer in a second direction opposite to the first direction when a third switching element and a fourth switching element are turned on is equal to or greater than a predetermined threshold.

### CROSS-REFERENCE TO RELATED APPLICATIONS

This application is based upon and claims the benefit of priority from Japanese Patent Application No. 2022-128136 filed on Aug. 10, 2022, the entire contents of which are incorporated herein by reference.

### FIELD

The present disclosure relates to a switching power supply device and a charging system.

### BACKGROUND

JP2016-131411A disclose a resonant power supply device that detects a time at which a current flowing through a primary side becomes 0 and a time at which the current becomes peak, and performs on-off control of a synchronous rectifier on a secondary side based on these times.

In a power supply device described in JP2016-131411A, it is necessary to detect a value of the current flowing through the primary side and the time, which complicates a control of a switching power supply device.

### SUMMARY

An object of an aspect of the present disclosure is to turn on and off a synchronous rectifier circuit on a secondary side of a transformer without detecting a value of a current flowing through a primary side and a time.

According to an aspect of the present disclosure, there is provided a switching power supply device usable for charging a battery, including: a transformer; a bridge circuit including a first switching element, a second switching element, a third switching element, and a fourth switching element; a resonant circuit connected between the primary side of the transformer and an output side of the bridge circuit; a synchronous rectifier circuit connected to the secondary side of the transformer; and a control unit. The control unit is configured to: fix a frequency of an on-off operation of a switching element on the primary side of the transformer; provide a predetermined phase difference between a timing at which the first switching element is turned on and a timing at which the second switching element is turned on, and provide the predetermined phase difference between a timing at which the third switching element is turned on and a timing at which the fourth switching element is turned on; and control the synchronous rectifier circuit to rectify the current flowing through the secondary side of the transformer at a timing when an absolute value of a first current flowing through the primary side of the transformer in a first direction when the first switching element and the second switching element are turned on is equal to or greater than a predetermined threshold or at a timing when an absolute value of a second current flowing through the primary side of the transformer in a second direction opposite to the first direction to the primary side of the transformer when the third switching element and the fourth switching element are turned on is equal to or greater than the predetermined threshold.

According to the above configuration, the synchronous rectifier circuit on the secondary side of the transformer can be turned on and off without detecting a value of the current flowing through the primary side and the time.

According to another aspect of the present disclosure, there is provided a charging system including: the switching power supply device according to the above aspect; and a battery. The charging system charges the battery by: a constant current charging using an output current of the switching power supply device; and a constant voltage charging using an output voltage of the switching power supply device. The constant current charging is performed while a battery voltage of the battery is equal to or higher than a first voltage value and equal to or lower than a second voltage value, and the constant voltage charging is performed after the battery voltage of the battery reaches a third voltage value equal to or higher than the second voltage value.

According to the above configuration, it is possible to prevent overcurrent charging by performing the constant current charging. Further, after the charging voltage of the battery reaches the third voltage, overcharge can be prevented by performing the constant voltage charging.

According to an aspect of the present disclosure, it is possible to turn on and off the synchronous rectifier circuit on the secondary side without detecting the value of the current flowing through the primary side and the time.

### BRIEF DESCRIPTION OF DRAWINGS

FIG. 1 is a diagram illustrating a configuration example of a charging system according to a first embodiment of the present disclosure;

FIG. 2 is a diagram showing an example of a charging profile of the charging system according to the first embodiment of the present disclosure;

FIGS. 3A and 3B are diagrams used for explaining a direction of a current flowing through a DC-DC converter;

FIG. 4 is an example of a timing chart showing an operation of each part of the DC-DC converter;

FIG. 5 is a diagram illustrating a configuration example of a charging system according to a second embodiment of the present disclosure;

FIG. 6 is a circuit diagram showing an example of a current detection circuit;

FIG. 7 is a diagram illustrating a configuration example of a charging system according to a third embodiment of the present disclosure; and

FIG. 8 is an example of a timing chart showing an operation of each part of a DC-DC converter.

### DETAILED DESCRIPTION

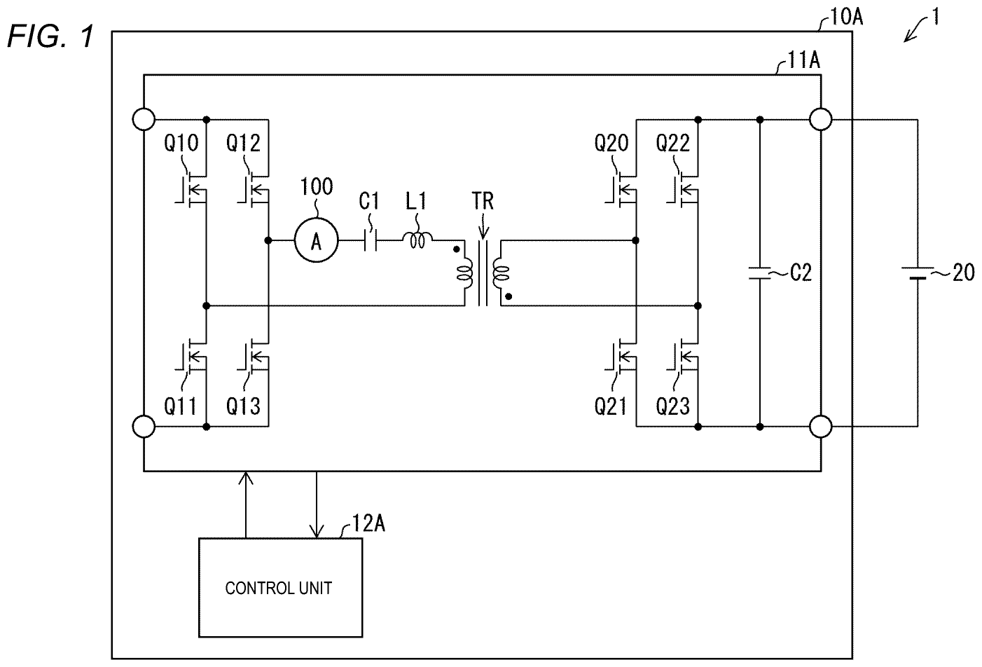

Hereinafter, an embodiment of the present disclosure will be described in detail. FIG. 1 is a configuration example of a charging system 1 according to a first embodiment of the present disclosure. The charging system 1 illustrated in FIG. 1 includes a switching power supply device 10A and a secondary battery 20. The secondary battery 20 is connected to a load side of the switching power supply device 10A.

The switching power supply device 10A includes a DC-DC converter 11A and a control unit 12A. The DC-DC converter 11A constitutes a full-bridge circuit and includes a reverse-wound transformer TR. A current detection unit 100, four switching elements Q10, Q11, Q12, and Q13, a capacitor C1 and a coil L1 constituting a resonance circuit, and a magnetizing inductance (not shown) built in the transformer TR are connected to a primary side of the transformer TR. The current detection unit 100 detects a current ILmp flowing through the primary side of the transformer TR.

Connected to a secondary side of the transformer TR are a smoothing capacitor C2 and four switching elements Q20, Q21, Q22, Q23 that constitute a synchronous rectifier circuit.

The switching element Q10 is an example of a first switching element, and includes an FET. The switching element Q13 is an example of a second switching element, and includes an FET. The switching element Q12 is an example of a third switching element, and includes an FET. The switching element Q11 is an example of a fourth switching element, and includes an FET. The switching element Q20 is an example of a fifth switching element, and includes an FET. The switching element Q23 is an example of a sixth switching element, and includes an FET. The switching element Q22 is an example of a seventh switching element, and includes an FET. The switching element Q21 is an example of an eighth switching element, and includes an FET. The switching elements Q10, Q11, Q12, Q13, Q20, Q21, Q22, and Q23 may be configured by IGBTs or bipolar transistors.

The frequencies of an on-off operations of the switching elements Q10, Q11, Q12, and Q13 are fixed, for example, to a resonance frequencies of the capacitor C1 and the coil L1.

The control unit 12A includes, for example, a microcomputer. A current value of the current ILmp flowing through the primary side of the transformer TR detected by the current detection unit 100 is input to the control unit 12A. The control unit 12A performs on-off control of the eight switching elements Q10, Q11, Q12, Q13, Q20, Q21, Q22, and Q23.

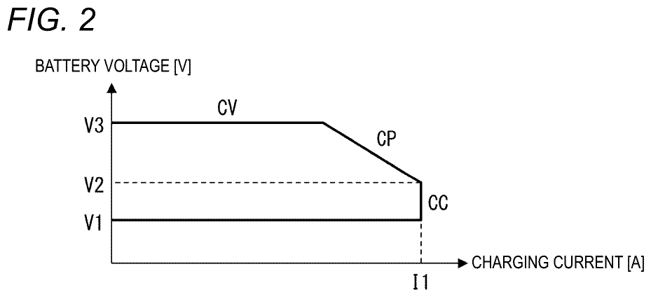

FIG. 2 shows a charging profile of the charging system 1. The charging system 1 can charge the secondary battery 20 by three charging methods of a constant current charging CC, a constant power charging CP, and a constant voltage charging CV.

The charging system 1 may charge the secondary battery 20 by at least the constant current charging CC and the constant voltage charging CV among the charging methods shown in FIG. 2. In addition, the charging system 1 may be capable of charging the secondary battery 20 by a charging method not shown in FIG. 2, for example, a pulse charging or a trickle charging.

When a battery voltage of the secondary battery 20 is equal to or higher than a first voltage V1 and equal to or lower than a second voltage V2, the charging system 1 charges the secondary battery 20 by the constant current charging CC. In the constant current charging CC, the charging system 1 outputs a charging current having a constant current value Il to the secondary battery 20 by using the current outputted from the switching power supply device 10A.

When the battery voltage of the secondary battery 20 is equal to or higher than the second voltage V2 and equal to or lower than a third voltage V3, the charging system 1 charges the secondary battery 20 by the constant power charging CP. In the constant power charging CP, the charging current decreases as the battery voltage of the secondary battery 20 increases. The third voltage V3 is a charging target value of the battery voltage of the secondary battery 20.

When the battery voltage of the secondary battery 20 reaches the third voltage V3, the charging system 1 charges the secondary battery 20 by the constant voltage charging CV. In the constant voltage charging CV, charging is performed with a constant charging voltage. In the constant voltage charging CV, an internal voltage of the secondary battery 20 increases and the charging current decreases.

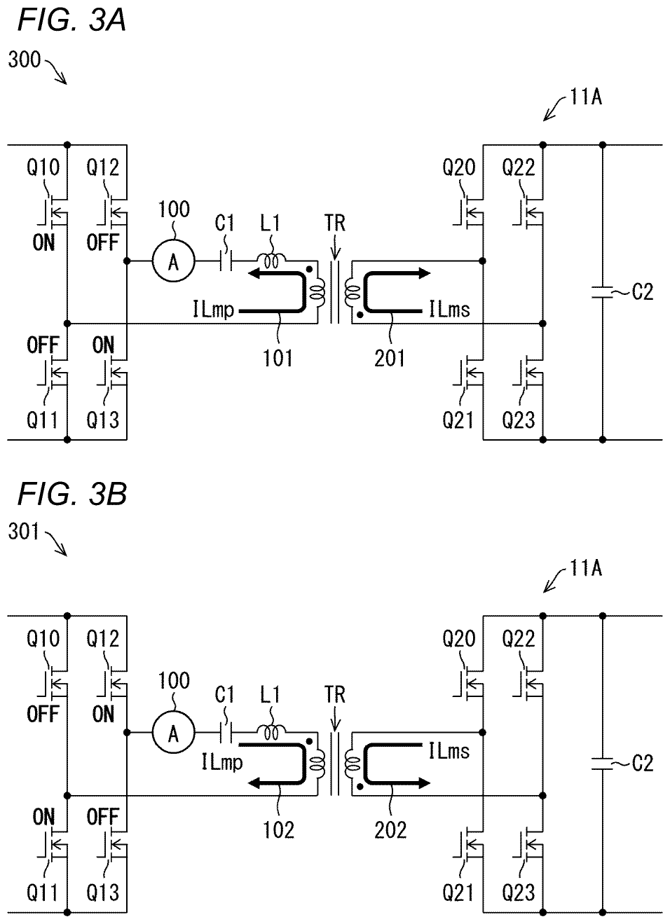

The relationship between the on-off operations of the switching elements Q10, Q11, Q12, and Q13 on the primary side of the transformer TR and the current ILmp flowing through the primary side of the transformer TR will be described with reference to FIG. 3A and FIG. 3B. FIGS. 3A and 3B show a direction of the current flowing through the DC-DC converter 11A. In the FIG. 3A, the switching elements Q10 and Q13 are turned on, and the switching elements Q11 and Q12 are turned off. At this time, the current ILmp flows through the primary side of the transformer TR in a first direction 101. At this time, the current ILms flows through the secondary side of the transformer TR in a third direction 201, and the current flows through the switching elements Q20 and Q23.

In FIG. 3B, the switching elements Q11 and Q12 are turned on, and the switching elements Q10 and Q13 are turned off. At this time, the current ILmp flows through the primary side of the transformer TR in a second direction 102. At this time, the current ILms flows through the secondary side of the transformer TR in a fourth direction 202, and the current flows through the switching elements Q21 and Q22.

The switching elements Q20 and Q23 may be damaged unless they are turned on at the timing when the current ILmp flows in the first direction 101 as shown in FIG. 3A. On the other hand, the switching elements Q21 and Q22 may be damaged unless they are turned on at the timing when the current ILmp flows in the second direction 102 as shown in FIG. 3B. Hereinafter, an appropriate on-off operation of the switching elements Q20, Q21, Q22, and Q23 by the control unit 12A of the switching power supply device 10A when the constant current charging CC is performed in the charging system 1 will be described.

A capacitance of the capacitor C1, a inductance of the coil L1, and a magnetizing inductance of the transformer TR included in the resonance circuit shown in FIG. 1 are set such that the ratio of a secondary-side voltage Vout to a primary-side voltage Vin of the transformer TR is, for example, less than 1 when the secondary battery 20 is charged by the constant current charging CC and a turns ratio of the transformer TR is assumed to be 1.

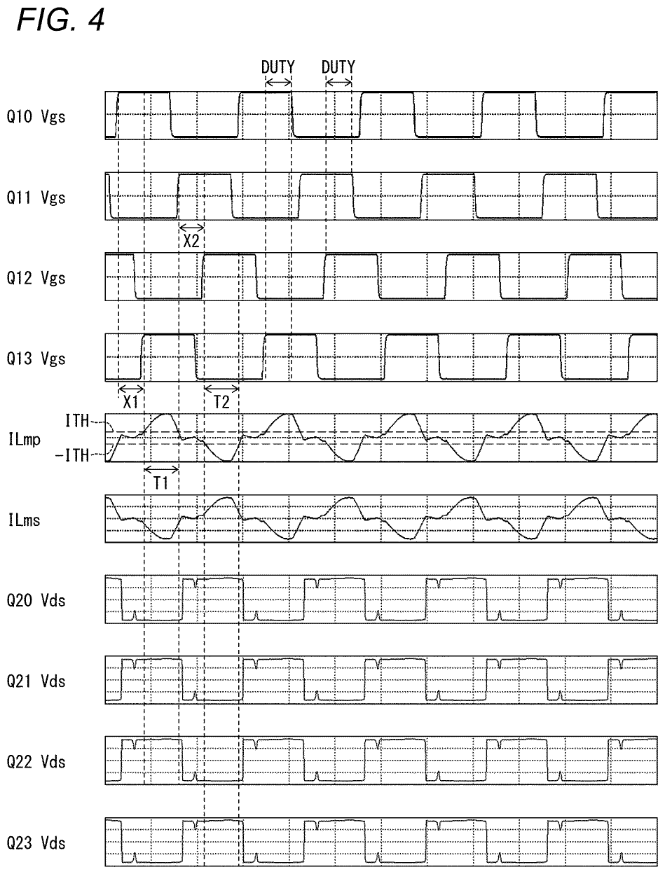

Turning on and off operations of the switching elements Q20, Q21, Q22, and Q23 will be described with reference to FIG. 4. FIG. 4 is a timing chart showing an operation of each part of the DC-DC converter 11A. FIG. 4 illustrates, from the top, a gate-source voltages of the switching elements Q10, Q11, Q12, and Q13, the current ILmp flowing through the primary side of the transformer TR detected by the current detection unit 100, the current ILms flowing through the secondary side of the transformer TR, and a drain-source voltages of the switching elements Q20, Q21, Q22, and Q23.

In FIG. 4, the current ILmp is represented by a positive value when flowing in the first direction 101 in FIG. 3A, and is represented by a negative value when flowing in the second direction 102 in FIG. 3B. The current ILms is represented by the positive value when flowing in the fourth direction 202 in FIG. 3B, and is represented by the negative value when flowing in the third direction 201 in FIG. 3A.

As shown in FIG. 4, the control unit 12A performs phase shift control in which a predetermined phase difference X1 is provided between the on-off operation of the switching element Q10 and the on-off operation of the switching element Q13. When the current ILmp detected by the current detection unit 100 becomes equal to or greater than a positive threshold ITH during a period in which the switching elements Q10 and Q13 are on, the control unit 12A turns on the switching elements Q20 and Q23 on the secondary side to rectify the current ILms flowing in the third direction 201. Thereafter, when the current ILmp becomes less than the positive threshold ITH, the control unit 12A controls the switching elements Q20 and Q23 on the secondary side to be turned off.

As shown in FIG. 4, the control unit 12A performs phase shift control in which a predetermined phase difference X2 is provided between the on-off operation of the switching element Q11 and the on-off operation of the switching element Q12. When the current ILmp detected by the current detection unit 100 becomes equal to or less than a negative threshold −ITH during a period in which the switching elements Q11 and Q12 are turned on, the control unit 12A performs control so that the switching elements Q21 and Q22 on the secondary side are turned on and the current ILms flowing in the fourth direction is rectified. Thereafter, when the current ILmp becomes larger than the negative threshold −ITH, the control unit 12A performs control so that the switching elements Q21 and Q22 on the secondary side are turned off.

That is, the control unit 12A performs control so as to turn on the switching elements of the secondary-side synchronous rectifier circuit through which the current flows during a period in which the absolute value of the current ILmp is equal to or larger than the predetermined threshold ITH. The addition, the control unit 12A control so as to turn off the switching elements of the secondary-side synchronous rectifier circuit through which the current flows during a period in which the absolute value of the current ILmp is less than the predetermined threshold ITH.

A period T1 in FIG. 4 is longer than a period DUTY in FIG. 4 during which both the switching elements Q10 and Q13 on the primary side, which are phase-shift-controlled, are turned on. A period T2 is longer than a period DUTY during which both the switching elements Q11 and Q12 on the primary side, which are phase-shift-controlled, are turned on.

The current ILms is smoothed by a smoothing capacitor C2 shown in FIG. 1 and is used for charging the secondary battery 20 by the constant current charging CC shown in FIG. 2. The voltage outputted from the switching power supply device 10A is used for charging the secondary battery 20 by the constant voltage charging CV.

A secondary battery 20 is connected to a load side of a switching power supply device 10A according to a first embodiment of the present disclosure, and the switching power supply device 10A can be used to charge the secondary battery 20. The switching power supply device 10A includes: a transformer TR; a bridge circuit including a first switching element Q10, a second switching element Q13, a third switching element Q12, and a fourth switching element Q11; a resonant circuit connected between a primary side of the transformer TR and an output side of the bridge circuit; a synchronous rectifier circuit connected to a secondary side of the transformer TR; a control unit 12A. The control unit 12A is configured to: fix a frequency of an on-off operation of a switching element on a primary side of the transformer TR; provide a predetermined phase shift X1 between a timing at which the first switching element Q10 is turned on and a timing at which the second switching element Q13 is turned on, and provide a predetermined phase shift X2 between a timing at which the third switching element Q13 is turned on and a timing at which the fourth switching element Q12 is turned on; and control the synchronous rectifier circuit to rectify a current flowing through the secondary side of the transformer TR at a timing when an absolute value of a first current ILmp flowing in a first direction 101 to the primary side of the transformer when the first and second switching elements Q10 and Q13 are turned on is equal to or larger than a predetermined threshold ITH or at a timing when an absolute value of a second current ILms flowing in a second direction 102 opposite to the first direction to the primary side of the transformer TR when the third and fourth switching elements Q12 and Q11 are turned on is equal to or larger than the predetermined threshold ITH.

According to the above configuration, the synchronous rectifier circuit on the secondary side of the transformer TR can be turned on and off without detecting a value of the current flowing through the primary side and a time.

In the switching power supply device 10A according to the first embodiment of the present disclosure, the synchronous rectifier circuit includes a fifth switching element Q20, a sixth switching element Q23, a seventh switching element Q22, and an eighth switching element Q21. The control unit 12A is configured to: control both the fifth switching element Q20 and the sixth switching element Q23 to be turned on at a timing when the first current ILmp is greater than or equal to the predetermined threshold ITH; and control both the seventh switching element Q22 and the eighth switching element Q21 to be turned on at a timing when the second current ILms is greater than or equal to the predetermined threshold ITH.

According to the above configuration, even when the four switching elements Q20, Q21, Q22, and Q23 are provided as the synchronous rectifier circuit on the secondary side of the transformer TR, the synchronous rectifier circuit can be turned on and off without detecting the value of the current flowing through the primary side and the time.

The switching power supply device 10A according to the first embodiment of the present disclosure further includes a current detection unit 100 that detects the first current ILmp and the second current ILms and outputs current values of the first current ILmp and the second current ILms to the control unit 12A. The control unit 12A is configured to: control both the fifth switching element Q20 and the sixth switching element Q23 to be turned on at a timing when an absolute value of the first current ILmp in the first direction 101 detected by the current detection unit 100 is equal to or greater than the predetermined threshold ITH; and control both the seventh switching element Q22 and the eighth switching element Q21 to be turned on at a timing when the absolute value of the second current ILms in the second direction 102 detected by the current detection unit 100 are equal to or greater than the predetermined threshold ITH.

According to the above configuration, since the switching power supply device 10A further includes the current detection unit 100, the control unit 12A can appropriately determine the timing at which the absolute values of the first current ILmp and the second current ILms are equal to or greater than the predetermined threshold ITH.

A charging system 1 according to the first embodiment of the present disclosure includes: the switching power supply device 10A; and the secondary battery 20. As shown in FIG. 2, the charging system 1 can charge the secondary battery 20 by: a constant current charging CC using a current outputted from the switching power supply device 10A; and a constant voltage charging CV using a voltage outputted from the switching power supply device 10A. The secondary battery 20 is charged by the constant current charging CC while a battery voltage of the secondary battery 20 is equal to or higher than a first voltage value V1 and equal to or lower than a second voltage value V2. After the battery voltage of the secondary battery 20 reaches a third voltage value V3 which is equal to or higher than the second voltage value V2, the secondary battery 20 is charged by the constant voltage charging CV.

According to the above configuration, it is possible to prevent overcurrent charging by performing the constant current charging CC. After the charging voltage of the secondary battery 20 reaches the third voltage V3, overcharge can be prevented by performing the constant voltage charging CV.

Other embodiments of the present disclosure will be described below. For convenience of description, members having the same functions as those described in the above embodiment are denoted by the same reference numerals, and description thereof will not be repeated.

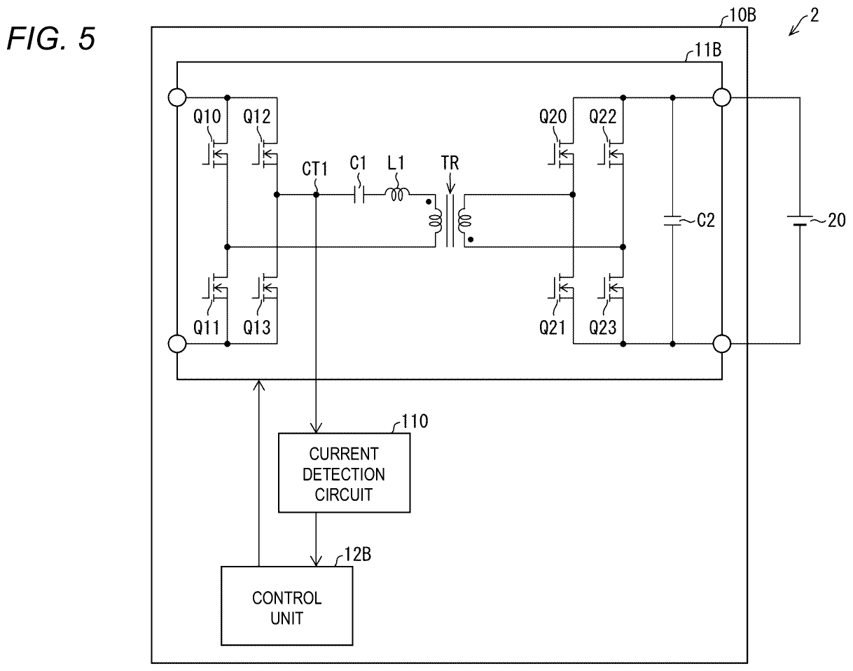

FIG. 5 illustrates a configuration example of a charging system 2 according to a second embodiment of the present disclosure. The charging system 2 shown in FIG. 5 includes a switching power supply device 10B and a secondary battery 20. The switching power supply device 10B includes a DC-DC converter 11B, a current detection circuit 110, and a control unit 12B.

In the current detection circuit 110, a current transformer is arranged at a measurement point CT1 shown in FIG. 5. The current transformer detects a current ILmp.

The current detection circuit 110 outputs a first signal at a timing when the current ILmp flowing in a first direction 101 or a second direction 102 is equal to or greater than a threshold ITH. On the other hand, a second signal is output at a timing at which the current ILmp flowing in the first direction 101 is less than the threshold ITH and the current ILmp flowing in the second direction 102 is less than the threshold ITH.

The control unit 12B performs on-off operations of switching elements Q10, Q11, Q12, and Q13 on a secondary side of a transformer TR based on on-off states of switching elements Q20, Q21, Q22, and Q23 on a primary side of the transformer TR and the first signal and the second signal output from the current detection circuit 110. For example, after the switching elements Q10 and Q13 on the primary side of the transformer TR are turned on, the switching elements Q20 and Q23 are turned on at the timing when the signal output from the current detection circuit 110 is switched from the second signal to the first signal.

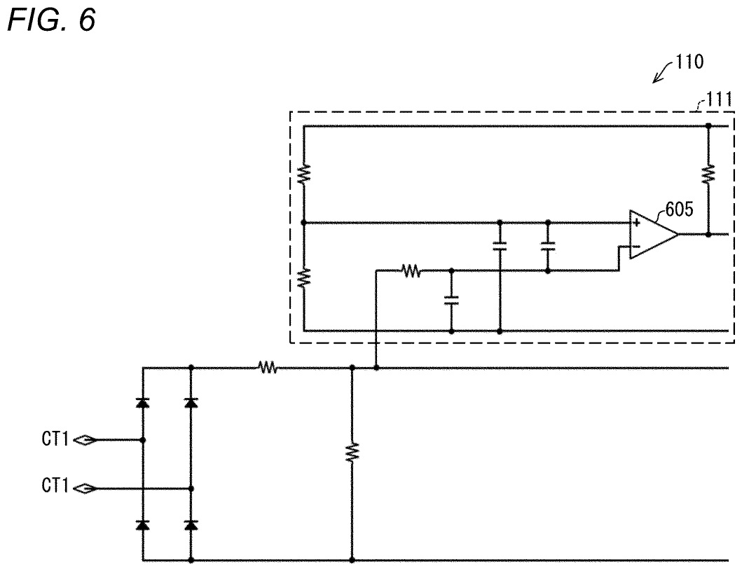

FIG. 6 shows a configuration example of the current detection circuit 110. The current detection circuit 110 illustrated in FIG. 6 includes a comparator 111. The comparator 111 is designed such that a voltage of a non-inverting input terminal of an operational amplifier 605 becomes a reference voltage corresponding to the threshold ITH of the current ILmp. The voltage corresponding to the current ILmp detected by the current transformer is input as the voltage of an inverting input terminal of the operational amplifier 605. The operational amplifier 605 of the comparator 111 outputs the first signal when the current ILmp becomes larger than the threshold ITH.

The switching power supply device 10B according to the second embodiment of the present disclosure further includes the current detection circuit 110 that outputs the first signal to the control unit 12B during a period in which the first current ILmp flowing in the first direction 101 or the second current ILms flowing in the second direction 102 is equal to or greater than the predetermined threshold ITH and outputs the second signal to the control unit 12B during a period in which the first current ILmp flowing in the first direction 101 is less than the predetermined threshold ITH and the second current ILms flowing in the second direction 102 is less than the predetermined threshold ITH. The control unit 12B controls the synchronous rectifier circuit using the first signal and the second signal output from the current detection circuit 110.

According to the above configuration, since the switching power supply device 10B further includes the current detection circuit 110, the control unit 12B can appropriately determine the period in which the absolute value of the first current ILmp is equal to or greater than the predetermined threshold ITH and the period in which the absolute value of the second current ILms is equal to or greater than the predetermined threshold ITH.

Other embodiments of the present disclosure will be described below. For convenience of description, members having the same functions as those described in the above embodiment are denoted by the same reference numerals, and description thereof will not be repeated.

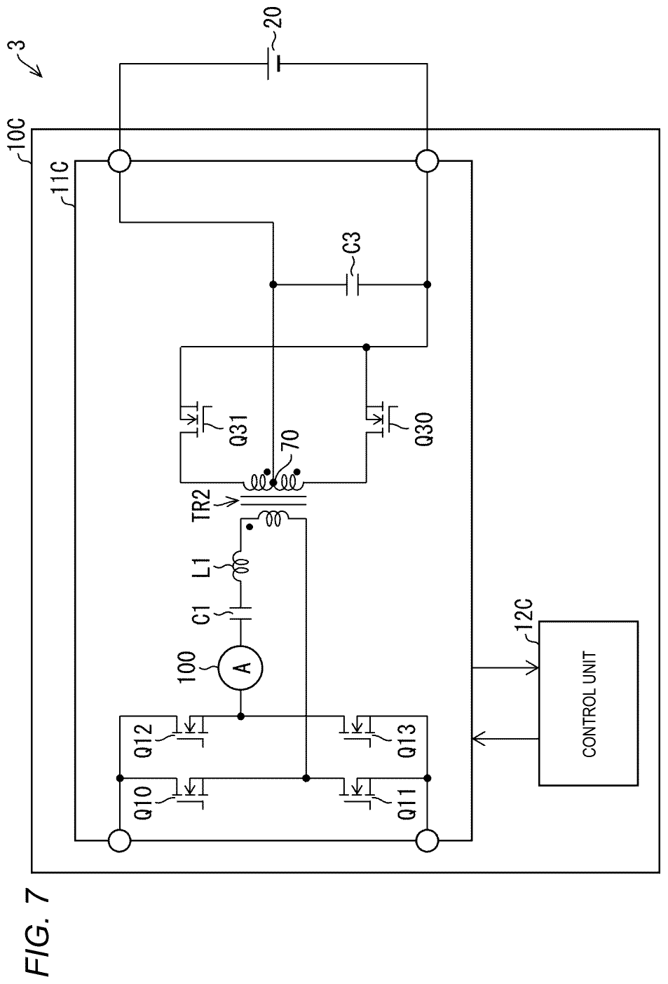

FIG. 7 illustrates a configuration example of a charging system 3 according to a third embodiment of the present disclosure. The charging system 3 shown in FIG. 7 includes a switching power supply device 10C and a secondary battery 20. The switching power supply device 10C includes a DC-DC converter 11C and a control unit 12C.

The DC-DC converter 11C has a transformer TR2 having a center tap terminal 70 on a secondary side. Connected to a primary side of the transformer TR2 are a current detection unit 100, four switching elements Q10, Q11, Q12, and Q13, a resonance circuit having a capacitor C1, a coil L1, and a magnetizing inductance (not shown) built in the transformer TR2.

On the secondary side of the transformer TR2, a smoothing capacitor C3 and two switching elements Q30 and Q31 constituting a synchronous rectifier circuit are connected.

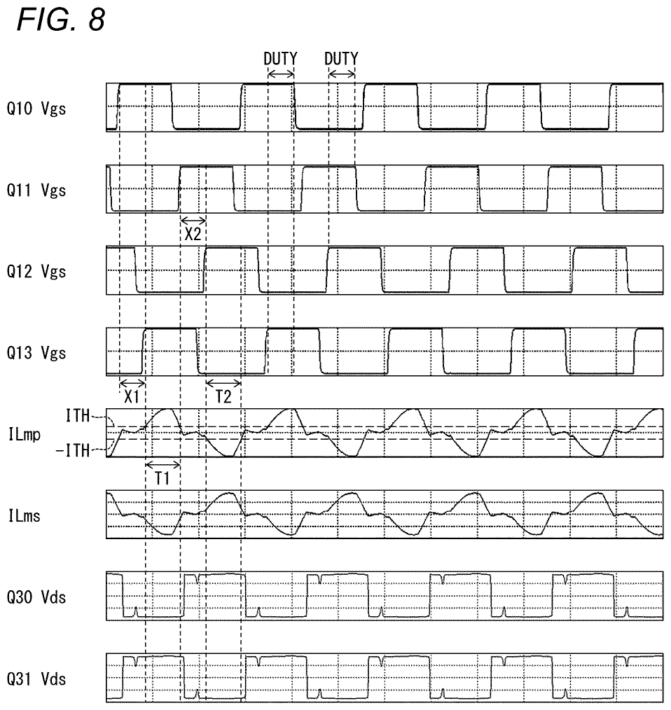

FIG. 8 is a timing chart showing an operation of each part of the DC-DC converter 11C. As shown in FIG. 8, the control unit 12C performs phase shift control in which a predetermined phase difference X1 is provided between the on-off operation of the switching element Q10 and the on-off operation of the switching element Q13. When a current ILmp in a first direction 101 shown in FIG. 3A becomes equal to or higher than a threshold ITH during a period in which the switching elements Q10 and Q13 are turned on, the control unit 12A controls a secondary-side switching element Q30 to be turned on. Thereafter, when the current ILmp in the first direction 101 becomes less than the threshold ITH, the control unit 12C controls the switching element Q30 on the secondary side to be turned off.

As shown in FIG. 8, the control unit 12C performs phase shift control in which a predetermined phase difference X2 is provided between the on-off operation of the switching element Q11 and the on-off operation of the switching element Q12. When the current ILmp in a second direction 102 shown in FIG. 3B becomes equal to or higher than the threshold ITH during a period in which the switching elements Q11 and Q12 are turned on, the control unit 12C controls a secondary-side switching element Q31 to be turned on. Thereafter, when the current ILmp in the second direction becomes less than the threshold ITH, the control unit 12C controls the switching element Q31 on the secondary side to be turned off.

In the switching power supply device 10C according to the third embodiment of the present disclosure, the transformer TR2 has the center tap terminal 70 on the secondary side. The synchronous rectifier circuit includes the fifth switching element Q30 and the sixth switching element Q31. The control unit 12C is configured to: control the fifth switching element Q30 to be turned on at a timing when the first current ILmp is greater than or equal to the predetermined threshold ITH; and control the sixth switching element Q31 to be turned on at a timing when the second current ILms is greater than or equal to the predetermined threshold ITH.

According to the above configuration, even when the center tap terminal 70 is provided on the secondary side of the transformer TR2 and the two switching elements are provided as the synchronous rectifier circuit provided on the secondary side of the transformer TR2, the synchronous rectifier circuit can be turned on and off without detecting a value of the current flowing through the primary side and a time.

The switching power supply device 10C according to the third embodiment of the present disclosure further includes a current detection unit 100 that detects the first current ILmp and the second current ILms and outputs the current values of the first current ILmp and the second current ILms to the control unit 12C.

The control unit 12C is configured to: control the fifth switching element Q30 to be turned on at a timing when an absolute value of the first current ILmp in the first direction 101 detected by the current detection unit 100 is equal to or greater than the predetermined threshold ITH; and control the sixth switching element Q31 to be turned on at a timing when the absolute value of the second current ILms in the second direction 102 detected by the current detection unit 100 is equal to or greater than the predetermined threshold ITH.

According to the above configuration, since the switching power supply device 10C further includes the current detection unit 100, the control unit 12C can appropriately determine the timing at which the absolute values of the first current ILmp and the second current ILms are equal to or greater than the predetermined threshold ITH.

In the charging system 1 according to the first embodiment and the charging system 3 according to the third embodiment described above, the control unit 12A performs control such that the period T1 in which the current ILmp flowing in the first direction 101 shown in FIG. 3A detected by the current detection unit 100 is equal to or greater than the threshold ITH includes a period in which all of the switching elements Q20 and Q23 on the secondary side are turned on. In addition, the control unit 12A performs control such that the period T2 in which the current ILmp flowing in the second direction 102 shown in FIG. 3B detected by the current detection unit 100 is equal to or greater than the threshold ITH includes a period in which all of the switching elements Q21 and Q22 on the secondary side are turned on. In other words, the control unit 12A performs control so that the period T2 illustrated as a period in which the current ILmp is equal to or less than the negative threshold −ITH in FIG. 4 includes the period in which all of the switching elements Q21 and Q22 on the secondary side are turned on. However, the period T1 and the period T2 may be measured at the time of design and development of the charging system 1, and the control unit 12A may perform switching control of the switching elements Q20, Q21, Q22, and Q23 on the secondary side based on the period T1 and the period T2 measured at the time of design and development.

The charging system 1 according to the first embodiment, the charging system 2 according to the second embodiment, and the charging system 3 according to the third embodiment are not limited to the above-described configurations, and may further include components other than the switching power supply devices 10A and 10B and the secondary batteries 20. For example, a power factor correction circuit may be further provided.

In the charging system 1 according to the first embodiment, the charging system 2 according to the second embodiment, and the charging system 3 according to the third embodiment described above, the resonance circuit is configured by the coil L1, the capacitor C1, and the magnetizing inductance incorporated in the transformer TR (not shown). However, the resonance circuit is not limited to this configuration, and may include elements other than these elements or may use parasitic elements (not shown). For example, the resonance circuit may be formed by using a leakage inductance (not shown) incorporated in the transformer TR instead of the coil L1. The transformer TR does not limit the winding method of the winding. Alternatively, a plurality of transformers may be used.

In the charging system 1 according to the first embodiment, the charging system 2 according to the second embodiment, and the charging system 3 according to the third embodiment, the capacitance of the capacitor C1, the inductance of the coil L1, and the magnetizing inductance of the transformer TR are set such that the ratio of the secondary-side voltage Vout to the primary-side voltage Vin of the transformer TR is, for example, less than 1 when the turns ratio of the transformer TR is assumed to be 1. However, the capacitor C1, the coil L1, and the magnetizing inductance of the transformer TR included in the resonance circuit are not limited to this configuration. For example, when the secondary battery 20 is charged by the constant current charging CC, the inductance and the capacitance may be set such that the ratio of the secondary-side voltage Vout to the primary-side voltage Vin of the transformer TR is, for example, 1 or more when the turns ratio of the transformer TR is assumed to be 1.

In the charging system 3 according to the third embodiment, the current detection unit 100 is provided on the primary side of the transformer TR2 to detect the current ILmp flowing through the primary side of the transformer TR. However, in the charging system 3 according to the third embodiment, the method of detecting the current ILmp is not limited to the current detection unit 100. For example, as in the charging system 2 according to the second embodiment, the current ILmp may be detected using the current detection circuit 110. Since the switching power supply device 10C includes the current detection circuit 110, the control unit 12C can appropriately determine the period in which the current ILmp in the first direction 101 is equal to or greater than the predetermined threshold ITH and the period in which the current ILmp in the second direction 102 is equal to or greater than the predetermined threshold ITH.

The present disclosure is not limited to the above-described embodiments, and various changes can be made within the scope of the claims. Embodiments obtained by appropriately combining technical means disclosed in different embodiments are also included in the technical scope of the present disclosure.

1. A switching power supply device usable for charging a battery, the switching power supply device comprising:
a transformer;
a bridge circuit including a first switching element, a second switching element, a third switching element, and a fourth switching element;
a resonant circuit connected between a primary side of the transformer and an output side of the bridge circuit;
a synchronous rectifier circuit connected to a secondary side of the transformer; and
a control unit,
wherein the control unit is configured to:
fix a frequency of an on-off operation of the switching elements on the primary side of the transformer;
provide a predetermined phase difference between a timing at which the first switching element is turned on and a timing at which the second switching element is turned on, and provide the predetermined phase difference between a timing at which the third switching element is turned on and a timing at which the fourth switching element is turned on; and
control the synchronous rectifier circuit to rectify a current flowing through the secondary side of the transformer at a timing when an absolute value of a first current flowing in a first direction to the primary side of the transformer when the first switching element and the second switching element are turned on is equal to or greater than a predetermined threshold or at a timing when an absolute value of a second current flowing in a second direction opposite to the first direction to the primary side of the transformer when the third switching element and the fourth switching element are turned on is equal to or greater than the predetermined threshold.

2. The switching power supply device according to claim 1,
wherein the synchronous rectifier circuit includes a fifth switching element, a sixth switching element, a seventh switching element, and an eighth switching element,
wherein the control unit is configured to:
control both the fifth switching element and the sixth switching element to be turned on at a timing at which the absolute value of the first current is equal to or greater than the predetermined threshold; and
control both the seventh switching element and the eighth switching element to be turned on at a timing at which the absolute value of the second current is equal to or greater than the predetermined threshold.

3. The switching power supply device according to claim 2, further comprising:
a current detection unit, the current detection unit being configured to detect the first current and the second current and output current values of the first current and the second current to the control unit,
wherein the control unit is configured to:
control both the fifth switching element and the sixth switching element to be turned on at a timing when the absolute value of the first current in the first direction detected by the current detection unit is equal to or greater than the predetermined threshold; and
control both the seventh switching element and the eighth switching element to be turned on at a timing when the absolute value of the second current in the second direction detected by the current detection unit is equal to or greater than the predetermined threshold.

4. The switching power supply device according to claim 2, further comprising:
a current detection circuit, the current detection circuit being configured to:
output a first signal to the control unit during a period in which the absolute value of the first current flowing in the first direction is equal to or greater than the predetermined threshold or during a period in which the absolute value of the second current flowing in the second direction is equal to or greater than the predetermined threshold; and
output a second signal to the control unit during a period in which the absolute value of the first current flowing in the first direction is less than the predetermined threshold and the absolute value of the second current flowing in the second direction is less than the predetermined threshold,
wherein the control unit is configured to:
control the synchronous rectifier circuit using the first signal and the second signal output from the current detection circuit.

5. The switching power supply device according to claim 1,
wherein the transformer includes a center tap terminal on the secondary side,
wherein the synchronous rectifier circuit includes a fifth switching element and a sixth switching element, and
wherein the control unit is configured to:
control the fifth switching element to be turned on at a timing at which the absolute value of the first current is equal to or greater than the predetermined threshold; and
control the sixth switching element to be turned on at a timing when the absolute value of the second current is equal to or greater than the predetermined threshold.

6. The switching power supply device according to claim 5, further comprising:
a current detection unit, the current detection unit being configured to detect the first current and the second current and output current values of the first current and the second current to the control unit,
wherein the control unit is configured to:
control the fifth switching element to be turned on at a timing when the absolute value of the first current in the first direction detected by the current detection unit is equal to or greater than the predetermined threshold; and
control the sixth switching element to be turned on at a timing when the absolute value of the second current in the second direction detected by the current detection unit is equal to or greater than the predetermined threshold.

7. The switching power supply device according to claim 5, further comprising:
a current detection circuit, the current detection circuit being configured to:
output a first signal to the control unit during a period in which the absolute value of the first current flowing in the first direction is equal to or greater than the predetermined threshold or during a period in which the absolute value of the second current flowing in the second direction is equal to or greater than the predetermined threshold; and
output a second signal to the control unit during a period in which the absolute value of the first current flowing in the first direction is less than the predetermined threshold and the absolute value of the second current flowing in the second direction is less than the predetermined threshold,
wherein the control unit is configured to:
control the synchronous rectifier circuit using the first signal and the second signal output from the current detection circuit.

8. A charging system comprising:
the switching power supply device according to any one of claim 1; and
a battery,
wherein the charging system charges the battery by:
a constant current charging using an output current of the switching power supply device; and
a constant voltage charging using an output voltage of the switching power supply device,
wherein the constant current charging is performed while a battery voltage of the battery is equal to or higher than a first voltage value and equal to or lower than a second voltage value, and
wherein the constant voltage charging is performed after the battery voltage of the battery reaches a third voltage value equal to or higher than the second voltage value.
